(19) United States
(12) Patent Application Publication
(10) Pub. No.: US 2015/0083069 A1
(43) Pub. Date: Mar. 26, 2015

(54) CHAIN DRIVE ASSEMBLY

(71) Applicant: Steven H. Horn, Oroville, CA (US)

(72) Inventor: Steven H. Horn, Oroville, CA (US)

(21) Appl. No.: 14/497,836

(22) Filed: Sep. 26, 2014

Related U.S. Application Data
(60) Provisional application No. 61/883,068, filed on Sep. 26, 2013.

(51) Int. Cl. F02B 63/00

(52) U.S. Cl. CPC F02B 63/00
USPC 123/198 R; 474/148

(57) ABSTRACT

A system is disclosed for a chain drive assembly. The system includes a first driving sprocket coupled with a crankshaft of the motor; and a second driving sprocket coupled with the crankshaft and positioned adjacent the first driving sprocket. The system also includes a first driven sprocket coupled with a first peripheral device, and a second driven sprocket coupled with a second peripheral device. In one embodiment, the system includes a first chain mechanically coupling the first driving sprocket and the first driven sprocket, and a second chain mechanically coupling the second driving sprocket with the second driven sprocket.

### CROSS-REFERENCES TO RELATED APPLICATIONS

This application claims the benefit of and claims priority to U.S. Provisional Patent Application No. 61/883,068 entitled “CHAIN DRIVE ASSEMBLY” and filed on Sep. 26, 2013 for Steven H. Horn, which is incorporated herein by reference.

### FIELD

This invention relates to systems for use with an automotive engine and its associated elements including pumps, compressors, and other elements, and more particularly relates to a chain drive system for providing a driving force to the associated elements.

### BACKGROUND

Internal combustion engines commonly used to power automobiles typically include a number of engine elements which are driven by the engine. Examples of these elements include, but are not limited to, an alternator for generating electricity, an air conditioning compressor, a water pump, a power steering pump, etc. These elements are typically driven by one or more drive belts that couple elements to a pulley mounted on an end of the crankshaft. As such, the elements are typically mounted at one end of the internal combustion engine (or motor).

A very active market has been established for the customization of all things related to internal combustion engines. Those that like to customize their automobile have the option to customize almost everything from the color or finish of the motor, to the color and type of material of hoses and cables. However, belt and pulley customization options are very limited.

### SUMMARY

A system for a chain drive assembly is disclosed. In one embodiment, the system includes a driving sprocket coupled with a driveshaft of the motor, at least one driven sprocket coupled with a peripheral device, and a chain mechanically coupling the driving sprocket and the at least one driven sprocket. The peripheral device may be selected from the group consisting of an alternator, a water pump, a power steering pump, and an air conditioning compressor.

In one embodiment, the driving sprocket is a first driving sprocket, and the system also includes a second driving sprocket coupled with the driveshaft and positioned adjacent the first driving sprocket. The second driving sprocket may be positioned at a distance from the motor greater than a distance between the motor and the first driving sprocket.

In another embodiment, a distance between the first driving sprocket and the second driving sprocket is in the range of between about 0.25″ and 3″, or 0.5″ and 1.5″. In a further embodiment, the chain comprises a double O-ring roller chain. The system may also include a turnbuckle disposed between the motor and the peripheral device and configured for adjusting the position of the peripheral device with respect to the motor, where the adjusting either decreases or increases a tension of the chain.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a perspective view diagram illustrating one embodiment of a motor in accordance with embodiments of the present invention;

FIG. 2 is an exploded view diagram of one embodiment of a chain suitable for use with embodiments of the invention;

FIG. 3 is a side perspective view diagram illustrating one embodiment of the motor in accordance with embodiments of the invention; and

FIG. 4 is a front perspective view of the motor in accordance with embodiments of the invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided to give a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

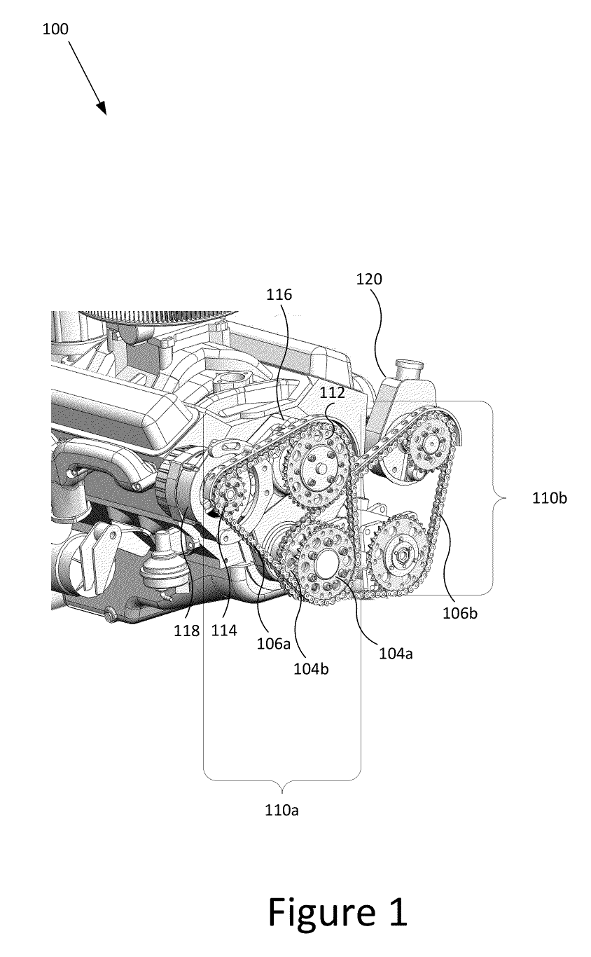

FIG. 1 is a perspective view diagram illustrating one embodiment of a motor 100 in accordance with embodiments of the present invention. One example of a motor suitable for use in accordance with embodiments of the present invention is an internal combustion small block engine, as depicted. In alternative embodiments, the components to be discussed are adaptable for use with any motor (e.g., automotive, motorcycle, etc.) that utilizes a drive assembly external to the motor 100 to engage peripheral devices. Examples of the peripheral devices include, but are not limited to, alternators, power steering pumps, water pumps, air conditioner compressors, air pumps, etc. Although a small-block engine is depicted, the components depicted and described may be adapted for use with big-block engines, or any engine that utilizes a drive assembly connected with a crankshaft or a driveshaft of the motor 100.

The motor 100, in one embodiment, utilizes an internal drive assembly that mechanically couples the crankshaft with a camshaft. A correct angular relationship or “timing” between the crankshaft and the camshaft is maintained by the internal drive assembly. The internal drive assembly may comprise chains or belts that engage crank sprockets and camshaft sprockets.

In one embodiment, a driving sprocket 104 is connected with the crankshaft of the motor 100. The driving sprocket 104 may be mechanically coupled with one or more peripheral devices. In a further embodiment, a second driving sprocket 104 may be positioned adjacent the first driving sprocket 104 on the crankshaft. Each of the first or second driving sprockets 104 may be mechanically coupled with one or more peripheral devices via an endless chain 106.

In the depicted embodiment, one or more drive assemblies that are external to the motor 100 may be configured. As used herein, the phrase “external drive assembly” refers to an assembly of at least one driving sprocket 104, at least one driven sprocket (e.g., water pump sprocket 112, alternator sprocket 114), and a chain 106 that mechanically couples the driving sprocket 104 with the driven sprockets.

The motor 100 may be configured with one or more external drive assemblies 110. In the depicted embodiment, the motor 100 is configured with first and second external drive assemblies 110. The first external drive assembly 110a includes a first driving sprocket 104a, a water pump sprocket 112, an alternator sprocket 114, and a first chain 106a that couples the sprockets together. In this example, the water pump sprocket 112 and the alternator sprocket 114 are driven sprockets. The water pump sprocket 112 is coupled with a water pump 116, and the alternator sprocket 114 is connected with an alternator 118. As such, the first driving sprocket 104a provides a driving force, via the first chain 106a to the water pump 116 and the alternator 118. In a similar manner, the second external drive assembly provides a driving force to other peripheral devices such as the power steering pump 120, and the air conditioning compressor 122.

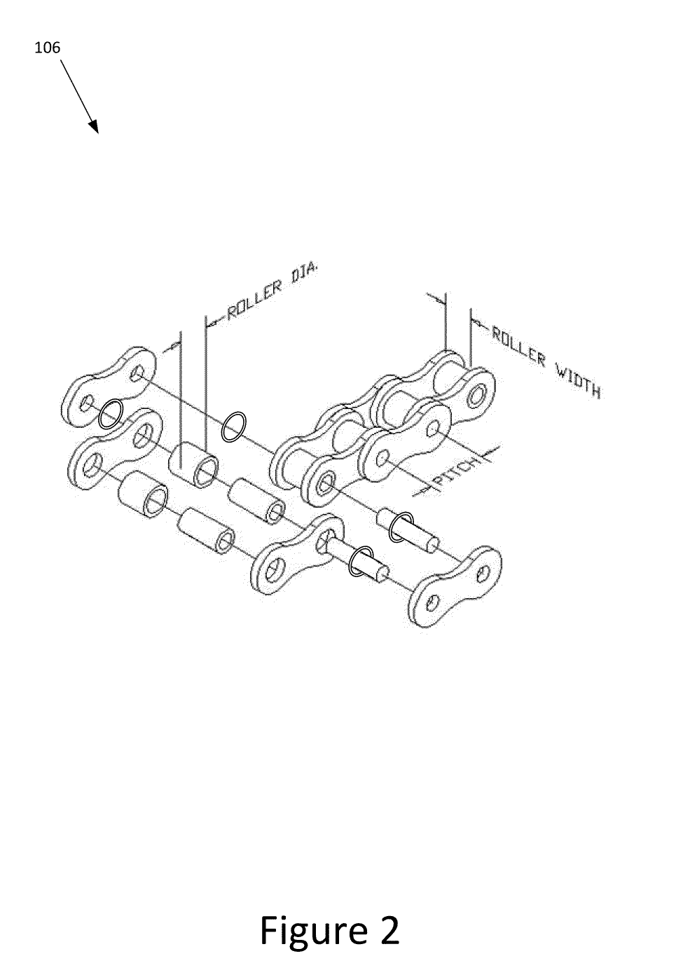

FIG. 2 is an exploded view diagram of one embodiment of a chain 106 suitable for use with embodiments of the invention. The chain 106, in one embodiment, is a double O-ring roller chain. The chain 106 may be selected according to the motor 100 type. For example, chains 106 having greater tension strength may be selected for motors having greater horsepower. Alternatively, the same type of chain 106 may be selected for each of the various types of motors.

The chain 106, in one embodiment, is a stainless steel chain. In other embodiments, the chain 106 is a composite chain having been formed of different materials, including but not limited to metals and plastics. In a further embodiment, the chain 106 is formed having a chrome finish. In another example, any finish (e.g., metal plating, plastic coating, etc.) desired may be applied to the chain 106. In other words, a person may select a finish (e.g., different colors, different materials, etc.) to match the color of the motor 100. Similarly, the hub and sprocket assembly depicted with reference to FIGS. 1, 3, and 4 may be color anodized to match or complement the color of the motor 100, the color of the vehicle, and/or the chain 106. In other words, any combination of colors may be selected for the chain 106 and sprockets.

The chain 106, in one example, is a #420 roller chain. The #420 roller chain may have a pitch, roller diameter, roller width, and sprocket thickness defined by the #420 chain standard. For example, the pitch may be about ½″, the roller diameter may be about 5/16″, and the roller width may be about ¼″. In an alternative embodiment, the pitch, roller diameter, roller width, and sprocket thickness are selected to emulate the dimensions of a serpentine belt or V-belt system that the external chain drive assembly replaces. In particular, the sprocket diameters are provided with a diameter that substantially approximates the diameter of a belt pulley. The length of the chain 106, accordingly, is substantially equivalent to the length of the serpentine or V-belt it replaces, in one embodiment.

In another embodiment, the chain 106 is an acetal case chain. Acetal case chains include links that are molded from acetal polymers and offer high tensile strength, excellent dynamic fatigue strength, and high resilience with a low co-efficient of friction. Additionally, acetal case chains require no lubrication and operate a lower noise levels. One example of an acetal (i.e., polyoxymethylene) chain suitable for use with the described embodiments is the stainless steel acetal roller chain available from McMaster-Carr of Elmhurst, Ill., having a ½″ pitch.

In an alternative embodiment, and as described above, the chain drive assembly may be configured as one or more external drive assemblies. Stated differently, more than one “sub-assemblies” may replace a single serpentine or V-belt system. Beneficially, the chain drive assembly as described herein provides better performance for high horsepower motors. Typically, v-belt and/or serpentine belt systems are subject to an amount of slippage when a high horsepower motor is accelerating. The chain drive assembly, however, overcomes this problem and prevents any slippage of the chain with respect to a peripheral.

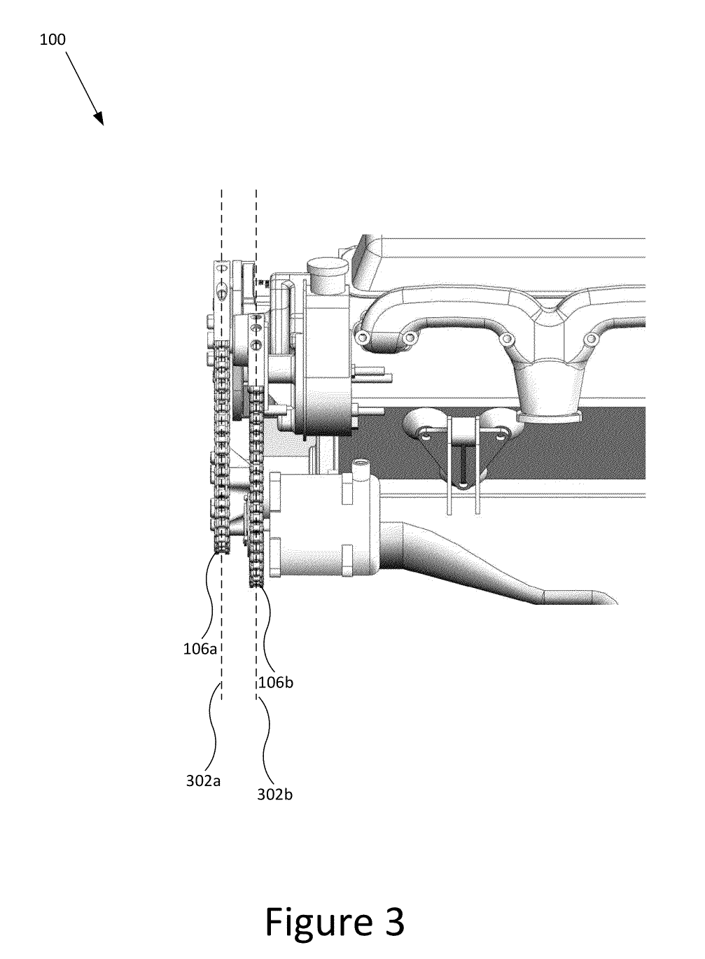

FIG. 3 is a side perspective view diagram illustrating one embodiment of the motor 100 in accordance with embodiments of the invention. As described above with reference to FIGS. 1 and 2, multiple external drive assemblies may replace a single serpentine or V-belt system. To accommodate multiple external drive assemblies, the chains 106a, 106b may be positioned at different distances from the motor 100. A vertical plane 302a, 302b may be defined by each chain 106a, 106b. The vertical planes 302a, 302b of the chains 106a, 106b, in one embodiment, are offset and co-planar.

In one embodiment, the vertical planes 302a, 302b bisect the corresponding chain 106a, 106b. The distance between the planes 302a, 302b is determined based on how the peripheral devices (e.g., alternator, water pump, etc.) are mounted to the motor 100. In one example, the distance between the vertical planes 302a, 302b, is in the range of between about 0.25″ and 3.″ In another embodiment, the distance between the vertical planes 302a, 302b is in the range of between about 0.5″ and 1.5.″

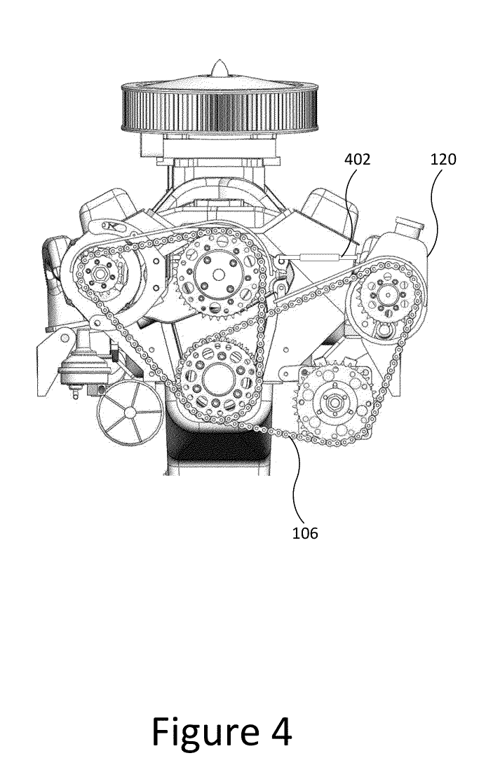

FIG. 4 is a front perspective view of the motor 100 in accordance with embodiments of the invention. In one embodiment, each external drive assemblies may be configured with a turnbuckle 402 for adjusting the tension of chains. The depicted embodiment illustrates a single turnbuckle 402 for adjusting the tension of the chain connected with the power steering pump and the air conditioning compressor. In another embodiment, the alternator may also be connected with the motor via a turnbuckle. As the turnbuckle 402 is rotated, the turnbuckle 402 either extends or retracts. This movement adjusts the positioning of the power steering pump 120, for example, and either increases or decreases the tension of the chain 106.

The subject matter of the present application has been developed in response to the present state of the art, and in particular, in response to the problems and needs in the art that have not yet been fully solved by currently available external drive systems. Accordingly, the subject matter of the present application has been developed to provide an external drive system that overcomes at least some shortcomings of the prior art.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the subject matter of the present disclosure may be combined in any suitable manner in one or more embodiments. One skilled in the relevant art will recognize that the subject matter may be practiced without one or more of the specific features or advantages of a particular embodiment. In other instances, additional features and advantages may be recognized in certain embodiments that may not be present in all embodiments. These features and advantages will become more fully apparent from the following description and appended claims, or may be learned by the practice of the subject matter as set forth hereinafter.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

Furthermore, the details, including the features, structures, or characteristics, of the subject matter described herein may be combined in any suitable manner in one or more embodiments. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the disclosed subject matter.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An external drive assembly for a motor comprising:
a driving sprocket coupled with a driveshaft of the motor;
at least one driven sprocket coupled with a peripheral device; and
a chain mechanically coupling the driving sprocket and the at least one driven sprocket.

2. The external drive assembly of claim 1, where the peripheral device is selected from the group consisting of an alternator, a water pump, a power steering pump, and an air conditioning compressor.

3. The external drive assembly of claim 1, where the driving sprocket is a first driving sprocket, and further comprising a second driving sprocket coupled with the driveshaft and positioned adjacent the first driving sprocket.

4. The external drive assembly of claim 3, where the second driving sprocket is positioned at a distance from the motor greater than a distance between the motor and the first driving sprocket.

5. The external drive assembly of claim 4, where a distance between the first driving sprocket and the second driving sprocket is in the range of between about 0.25″ and 3″.

6. The external drive assembly of claim 4, where a distance between the first driving sprocket and the second driving sprocket is in the range of between about 0.5″ and 1.5″.

7. The external drive assembly of claim 1, where the chain comprises a double O-ring roller chain.

8. The external drive assembly of claim 1, further comprising a turnbuckle disposed between the motor and the peripheral device and configured for adjusting the position of the peripheral device with respect to the motor, where the adjusting either decreases or increases a tension of the chain.

9. A system for an external drive assembly of a motor, the system comprising:
a first driving sprocket coupled with a crankshaft of the motor;
a second driving sprocket coupled with the crankshaft and positioned adjacent the first driving sprocket;
at least a first driven sprocket coupled with a first peripheral device;
at least a second driven sprocket coupled with a second peripheral device;
a first chain mechanically coupling the first driving sprocket and the at least first driven sprocket; and
a second chain mechanically coupling the second driving sprocket with the at least second driven sprocket.

10. The system of claim 9, where each of the first peripheral device and the second peripheral device is selected from the group consisting of an alternator, a water pump, a power steering pump, and an air conditioning compressor.

11. The system of claim 9, where the second driving sprocket is positioned at a distance from the motor greater than a distance between the motor and the first driving sprocket.

12. The system of claim 9, where a distance between the first driving sprocket and the second driving sprocket is in the range of between about 0.25″ and 3″.

13. The system of claim 9, where a distance between the first driving sprocket and the second driving sprocket is in the range of between about 0.5″ and 1.5″.

14. The system of claim 9, where the chain comprises a double O-ring roller chain.

15. The system of claim 9, further comprising a first turnbuckle disposed between the motor and the at least first peripheral device and configured for adjusting the position of the first peripheral device with respect to the motor, where the adjusting either decreases or increases a tension of the first chain.

16. The system of claim 15, further comprising a second turnbuckle disposed between the motor and the at least second peripheral device and configured for adjusting the position of the second peripheral device with respect to the motor, where the adjusting either decreases or increases a tension of the second chain.

17. A system comprising:
an internal combustion motor having an external drive assembly configured for providing a driving force to a plurality of peripheral devices via a crankshaft, where the external drive assembly comprises:
a first driving sprocket coupled with a crankshaft of the motor, a second driving sprocket coupled with the crankshaft and positioned adjacent the first driving sprocket at a distance from the motor greater than a distance between the first driving sprocket and the motor,
at least a first driven sprocket coupled with a first peripheral device of the plurality of peripheral devices,
at least a second driven sprocket coupled with a second peripheral device of the plurality of peripheral devices,
a first chain mechanically coupling the first driving sprocket and the at least first driven sprocket, and
a second chain mechanically coupling the second driving sprocket with the at least second driven sprocket.

18. The system of claim 17, where each of the first peripheral device and the second peripheral device is selected from the group consisting of an alternator, a water pump, a power steering pump, and an air conditioning compressor.

19. The system of claim 17, further comprising a first turnbuckle disposed between the motor and the at least first peripheral device and configured for adjusting the position of the first peripheral device with respect to the motor, where the adjusting either decreases or increases a tension of the first chain.

20. The system of claim 19, further comprising a second turnbuckle disposed between the motor and the at least second peripheral device and configured for adjusting the position of the second peripheral device with respect to the motor, where the adjusting either decreases or increases a tension of the second chain.
